(19) United States
(12) Patent Application Publication
(10) Pub. No.: US 2004/0131507 A1
(43) Pub. Date: Jul. 8, 2004

(54) Method and device for continous redox adjustment in azoic couplings

(76) Inventors: Klaus Saitmacher, Kriftel (DE); Hans-Peter Gabski, Alsbach-Haehnlein (DE); Harald Heider, Kelkheim (DE); Juergen Patzlaff, Rossdorf (DE); Christian Wille, Weinheim (DE); Joerg Jung, Floersheim (DE)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/468,472

(22) PCT Filed: Feb. 19, 2002
(86) PCT No.: PCT/EP02/01718

(30) Foreign Application Priority Data
Feb. 23, 2001 (DE) 10108716.0

(51) Int. Cl. G05D 7/00

(52) U.S. Cl. 422/111

(57) ABSTRACT

The invention relates to a method for adjusting the dosage of reaction components in a continuous azoic coupling reaction characterized in that the redox potential of the reaction mixture is measured online in the main flow after it exits from a continually operated reactor in a flow measurement cell with the aid of a rotating redox electrode which is arranged crosswise in relation to the direction of flow of the reaction mixture. The invention also relates to a flow measurement cell for carrying out said method, characterized by the following: a rotating redox electrode (1) which is arranged approximately in the middle of the flow pipe (2) of the flow measurement cell in a crosswise position with relation to the direction of flow of the reaction mixture and rotatably mounted in a sliding contact (3) for picking up a signal; a rod-shaped body (4) which enters into contact with the rotating redox electrode and which has a cleaning effect; a reference electrode (5) and a pH electrode (6).

Method and device for continuous redox adjustment in azoic couplings

The present invention relates to a method of online control of a continuous azo coupling reaction and also to a suitable measuring cell and device for implementing said method.

In the preparation of azo colorants in continuously operated reactors it is necessary to meter the coupling component and the diazo component in accordance with the reaction stoichiometry in the flowing reaction mixture in such a way as to achieve an extremely consistent, high product quality at the same time as maximum yield.

Traversed vessels for the measurement of the redox potential such as are used in batchwise-operated reactors for the preparation of azo dyes (DE-A-2 352 735) cannot be used. The reason for this is the large measurement volume, a consequence of the type of construction, and the associated long dead time in detecting changes in the redox potential.

Online regulation of reactant streams in continuously operated reactors for the implementation of azo coupling reactions has not been disclosed to date.

The object was therefore to provide a sensitive regulation method for continuous azo coupling, preferably in microreactors, which provides azo colorants in high yield with consistently good product quality. A further object is to provide a suitable device and measuring cell for implementing said method.

This object has been achieved by an innovative flow-traversed measuring cell downstream of the continuous reactor and by online regulation of the reactant streams by means of redox potential measurements in the flow-traversed measuring cell.

The invention accordingly provides a method of regulating the metered addition of the reaction components in a continuous azo coupling reaction, which comprises measuring the redox potential of the reaction mixture online in the main flow, following its exit from a continuously operated reactor, in a flow-traversed measuring cell with the aid of a rotating redox electrode disposed transversely with respect to the flow direction of the reaction mixture.

In the method of the invention the metered addition of the coupling component, the diazo component or both components can be regulated online: for example, a reactant stream A containing a solution or suspension of the coupling component, a reactant stream B containing a solution or suspension of the diazo component, and, where appropriate, a volume stream C containing a buffer solution, an acid or an alkali for setting a defined pH.

The metering of the reaction components appropriately takes place by comparison of the measurement signal of the redox electrode with the setpoint value of a preset redox potential at constant pH. It is therefore appropriate, in addition to a redox regulating circuit which connects the measuring cell with the reactant streams A and B, to set up a second regulating circuit, connecting a pH electrode in the flow-traversed measuring cell with the volume flow C, in order to keep the pH constant.

In practice the normal procedure is that the redox potential required is determined as a function of the nature and concentration of the coupling component and of the diazo component, in other words as a function of the azo colorant to be prepared. For this purpose, in the product stream or in a collecting vessel, after a certain reaction time has elapsed, which is dependent on the type of azo colorant to be prepared, testing is carried out for any excess of one component by means of suitable analytical techniques (e.g., spot test, HPLC). In dependence on this result the reactant stream A and/or B are corrected. If it is no longer possible to determine an excess of one of the reactants, the redox potential is fixed. For the further course of the azo coupling reaction, any deviation from this fixed redox potential is corrected by appropriately modifying the reactant streams A and/or B. For keeping the pH constant the volume stream C for the inflow of alkali, acid or buffer solution is controlled in an independent regulating circuit.

The azo coupling reaction can be carried out in accordance with the invention for the preparation of azo pigments and of azo dyes.

Of particular interest for azo pigments are the diazonium salts of the following amine components: 4-methyl-2-nitrophenylamine, 4-chloro-2-nitrophenylamine, 3,3-dichloro-biphenyl4,4′-diamine, 3,3-dimethylbiphenyl-4,4′-diamine, 4-methoxy-2-nitrophenylamine, 2-methoxy-4-nitrophenylamine, 2-methoxy-4-nitrophenylamine, 4-amino-2,5-dimethoxy-N-phenylbenzenesulfonamide, dimethyl 5-aminoisophthalate, anthranilic acid, 2-trifluoromethylphenylamine, dimethyl 2-amino-terephthalate, 1,2-bis(2-aminophenoxy)ethane, diisopropyl 2-aminoterephthalate, 2-amino-4-chloro-5-methylbenzenesulfonic acid, 2-methoxyphenylamine, 4-(4-aminobenzoylamino)benzamide, 2,4-dinitrophenylamine, 3-amino-4-methylbenzamide, 3-amino-4-chlorobenzamide, 3-amino-4-chlorobenzoic acid, 4-nitrophenylamine, 2,5-dichlorophenylamine, 4-methyl-2-nitrophenyl-amine, 2-chloro-4-nitrophenylamine, 2-methyl-5-nitrophenylamine, 2-methyl-4-nitrophenylamine, 2-methyl-5-nitrophenylamine, 2-amino-4-chloro-5-methylbenzenesulfonic acid, 2-aminonaphthalene-1-sulfonic acid, 2-amino-5-chloro-4-methylbenzenesulfonic acid, 2-amino-5-chloro-4- methylbenzenesulfonic acid, 2-amino-5-methylbenzenesulfonic acid, 2,4,5-trichlorophenylamine, 3-amino-4-methoxy-N-phenylbenzamide, 4-amino-benzamide, methyl 2-aminobenzoate, 4-amino-5-methoxy-2,N-dimethyl- benzenesulfonamide, monomethyl 2-amino-N-(2,5-dichlorophenyl)-terephthalate, butyl 2-aminobenzoate, 2-chloro-5-trifluoromethylphenyl- amine, 4-(3-amino-4-methylbenzoylamino)benzenesulfonic acid, 4-amino-2,5-dichloro-N-methylbenzenesulfonamide, 4-amino-2,5-dichloro-N,N-dimethylbenzenesulfonamide, 6-amino-1H-quinazoline-2,4-dione, 4-(3-amino-4-methoxybenzoylamino)benzamide, 4-amino-2,5-dimethoxy-N-methylbenzenesulfonamide, 5-aminobenzimidazolone, 6-amino-7-methoxy-1,4-dihydroquinoxaline-2,3-dione, 2-chloroethyl 3-amino-4-methylbenzoate, isopropyl 3-amino-4-chlorobenzoate, 3-amino-4-chlorobenzotrifluoride, n-propyl 3-amino-4-methylbenzoate, 2-aminonaphthalene-3,6,8-trisulfonic acid, 2-aminonaphthalene-4,6,8-trisulfonic acid, 2-aminonaphthalene-4,8-disulfonic acid, 2-aminonaphthalene-6,8-disulfonic acid, 2-amino-8-hydroxynaphthalene-6-sulfonic acid, 1-amino-8-hydroxynaphthalene-3,6-disulfonic acid, 1-amino-2-hydroxybenzene-5-sulfonic acid, 1-amino-4-acetylaminobenzene-2-sulfonic acid, 2-aminoanisole, 2-amino-methoxybenzene-co-methanesulfonic acid, 2-aminophenol-4-sulfonic acid, o-anisidine-5-sulfonic acid, 2-(3-amino-1,4-dimethoxybenzenesulfonyl)ethyl sulfate, and 2-(1-methyl-3-amino-4-methoxybenzenesulfonyl)ethyl sulfate.

Of particular interest for azo dyes are the diazonium salts of the following amine components: 2-(4-aminobenzenesulfonyl)ethyl sulfate, 2-(4-amino-5-methoxy-2-methyl-benzenesulfonyl)ethyl sulfate 2-(4-amino-2,5-dimethoxybenzenesulfonyl)-ethyl sulfate, 2-[4-(5-hydroxy-3-methylpyrazol-1-yl)benzenesulfonyl]ethyl-sulfate, 2-(3-amino-4-methoxybenzenesulfonyl)ethyl sulfate, 2-(3-amino-benzenesulfonyl)ethyl sulfate.

Of particular interest for azo pigments are the following coupling components: Acetoacetarylides

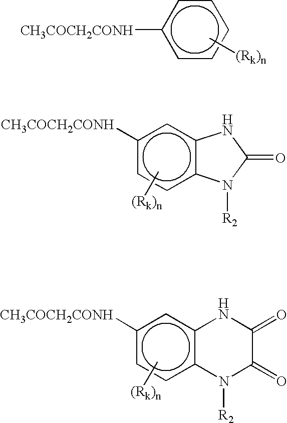

2-hydroxynaphthalenes

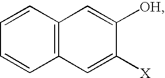

with X=H, COOH,

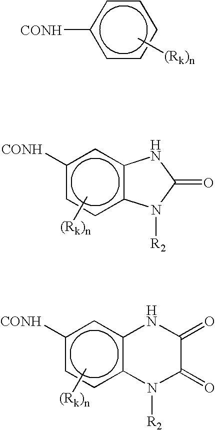

and Rₖ=CH_{3,} OCH₃, OC₂H_{5,} NO_{2,} Cl, NHCOCH_{3,} and n =0 to 3; and also R₂ =H, CH₃, and C₂H_{5,} bisacetoacetylated diaminobenzenes and -biphenyls, N,N′-bis(3-hydroxy-2-naphthoyl)phenylenediamine (in each case substituted if desired), and also pyrazolones

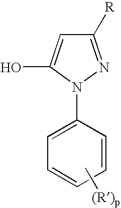

with R =CH₃, COOCH₃, COOC₂H₅,

with R =CH₃, COOCH₃, COOC₂H₅, R′=CH₃, SO₃H, Cl; p =0 to 3.

Of particular interest for azo dyes are the following coupling components: 4-[5-hydroxy-3-methylpyrazol-1 -yl]benzenesulfonic acid, 2-amino-naphthalene-1,5-disulfonic acid, 5-methoxy-2-methyl-4-[3-oxobutyryl-amino]benzenesulfonic acid, 2-methoxy-5-methyl-4-[3-oxobutyrylamino]-benzenesulfonic acid, 4-acetylamino-2-aminobenzenesulfonic acid, 4-[4-chloro-6-(3-sulfophenylamino)-[1,3,5]-triazin-2-yl-amino]-5-hydroxy-naphthalene-2,7-disulfonic acid, 4-acetylamino-5-hydroxynaphthalene-2,7-disulfonic acid, 4-amino-5-hydroxynaphthalene-2,7-disulfonic acid, 5-hydroxy-1 -[4-sulfophenyl]-1 H-pyrazole-3-carboxylic acid, 2-amino-naphthalene-6,8-disulfonic acid, 2-amino-8-hydroxynaphthalene-6-sulfonic acid, 1-amino-8-hydroxynaphthalene-3,6-disulfonic acid, 2-aminoanisole, 2-aminomethoxybenzene-ω-methanesulfonic acid and 1,3,5-trishydroxy-benzene.

The azo coupling takes place preferably in aqueous solution although it is also possible to use organic solvents, where appropriate in a mixture with water, examples being aromatic hydrocarbons, chlorinated hydrocarbons, glycol ethers, nitriles, esters, dimethylformamide, tetramethylurea, and N-methylpyrrolidone.

For inventive implementation of the azo coupling reaction a solution or suspension of the diazonium salt (reactant stream B) and a solution or suspension of the coupling component (reactant stream A) are introduced continuously into the reactor, where they are mixed continuously with one another and brought to reaction.

The preparation of mixtures of starting materials for volume streams can also take place beforehand in micromixers or in upstream mixing zones. For the azo coupling it is possible to supply buffer solutions (volume stream C) to the reactant streams, the buffer solutions preferably being those of organic acids and their salts, e.g., acetic acid/acetate buffer, citric acid/citrate buffer, or of inorganic acids and their salts, such as phosphoric acid/phosphate or carbonic acid/carbonate, for example.

Azo pigments may be monoazo pigments or disazo pigments. It is also possible to prepare mixtures of azo pigments.

Particularly suitable azo pigments include C.I. Pigment Yellow 1, 3, 12, 13, 14, 16, 17, 65, 73, 74, 75, 81, 83, 97, 111, 120, 126,.127, 151, 154, 155, 174,175,176,180,181, 183, 191, 194,198; Pigment Orange 5, 34, 36, 38, 62, 72, 74; Pigment Red 2, 3, 4, 8, 12, 14, 22, 48:1-4, 49:1, 52:1-2, 53:1-3, 57:1, 60:1, 112, 137, 144, 146, 147, 170, 171, 175, 176, 184, 185, 187, 188, 208, 214, 242, 247, 253, 256, 266; Pigment Violet 32; Pigment Brown 25.

The dyes suitably. include disperse, dyes and also water-soluble anionic and cationic dyes. In particular the dyes in question are monoazo, disazo or polyazo dyes and also formazan dyes or anthraquinone dyes. The water-soluble dyes include in particular the alkali metal salts or ammonium salts of the reactive dyes and also the acidic wool dyes or substantive cotton dyes of the azo series. Suitable azo dyes include preferably metal-free and metalatable monoazo, disazo, and trisazo dyes which contain one or more sulfonic acid or carboxylic acid groups, heavy metal azo dyes, i.e., copper, chromium or cobalt monoazo, disazo, and trisazo dyes. The precursors for the metal dyes can be prepared by standard methods in a conventional batch process.

Suitable reactive azo dyes include in particular C.I. Reactive Yellow 15,17, 37, 57, 160: Reactive Orange 107; Reactive Red 2, 23, 35, 180; Reactive Violet 5; Reactive Blue 19, 28, 203, 220; and Reactive Black 5, 8, 31. Furthermore, it is possible in particular to prepare C.I. Acid Yellow 17, 23; Direct Yellow 17, 86, 98, 132, 157; and Direct Black 62, 168, and 171 by this method.

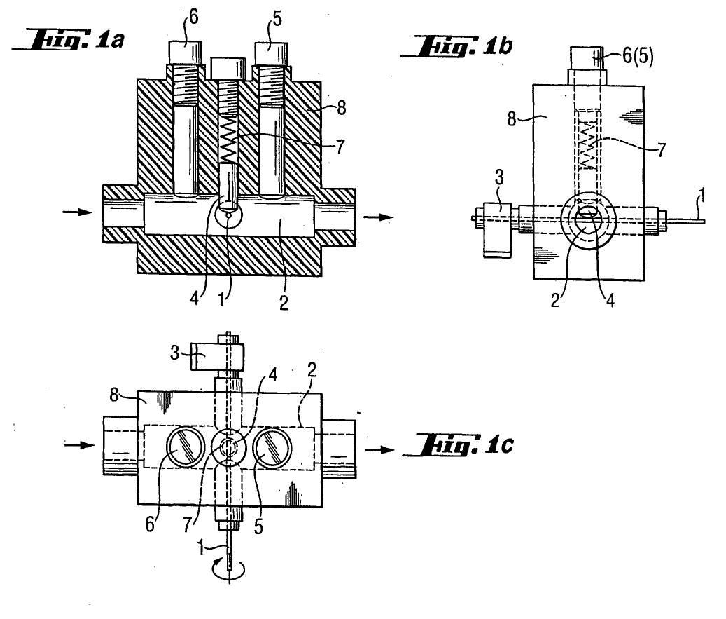

For implementing the method a flow measurement cell (FIG. 1a, 1b, 1c) has proven appropriate which is characterized by a rotating redox electrode (1) arranged approximately in the middle of the flow tube (2) of the flow measurement cell transversely in relation to the flow direction of the reaction mixture and rotatably mounted in a sliding contact (3) for picking up a signal; a rod-shaped body (4) which contacts the rotating redox electrode and has a cleaning action; a reference electrode (5); and a pH electrode (6).

The rotating redox electrode (1) is composed of a conducting material, preferably of W, Au, Pt, Ag, Sb, Mo, Cr or an alloy thereof, or of graphite or of at least 80% of one of the listed materials. Particular preference is given to redox electrodes of tungsten.

The redox electrode is mounted rotatably, in a Cu bush, for example, and is set in rotation about its longitudinal axis by means of an external drive device, an electric motor for example. Signal pickup takes place by way of a sliding contact in the bearing position. Acting as counterelectrode is the reference electrode (5), which is preferably a commercially customary Ag/AgCl electrode, calomel electrode or Pt/H₂ standard hydrogen electrode.

In the course of its rotation the redox electrode (1) is contacted by a rod-shaped body (4) composed or coated with an inert material, e.g., polyvinylidene difluoride (PVDF), polytetrafluoroethylene (PTFE), more preferably composed or coated with an abrasive material, such as corundum, Arkansas stone or silicone carbide, for example, so that the electrode surface is continuously mechanically cleaned. The body (4) is appropriately pressed onto the rotating redox electrode by means of a tracking device (7), in particular a helical spring or a weight. The point of contact between the body (4) and the redox electrode is situated preferably in the middle of the flow tube (2) and at this point (measurement site) reduces the flow cross section. As a result, the dead volume is kept small. The measurement cell further comprises a pH electrode (6), such as a commercially customary glass electrode, for example.

The measurement cell is appropriately constructed such that the pH electrode (6), the reference electrode (5), and the rod-shaped body (4) including tracking device stand parallel to one another and are each arranged offset by 90° with respect to the rotating redox electrode and vertically with respect to the flow direction. The housing (8) of the measurement cell is appropriately manufactured from an inert material, such as PVDF, PTFE or polypropylene, for example.

FIG. 1b shows the measurement cell viewed in the direction of flow, and FIG. 1c shows a plan view from above.

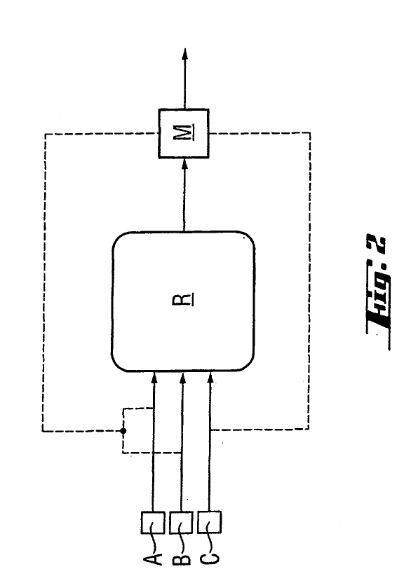

The invention also provides a device (FIG. 2) for implementing a continuous online-regulated azo coupling reaction, characterized by a flow measurement cell (M), as described above, connected to a continuously operated reactor (R) and reservoir vessels (A, B, and, where appropriate, C). Suitable continuously operated reactors include flow tubes, stirred tank cascades, microreactors or microjet reactors, especially those having flow cross sections in the micrometer to millimeter range. Microreactors and microjet reactors are preferred.

Suitable microreactors are described, for example, in DE-A-100 05 550 (PCT/EP 01/01137) or microjet reactors in German patent application 10 049 200.2, unpublished at the priority date of the present specification.

A microreactor is composed, for example, of a plurality of platelets joined to one another and stacked on top of one another, the surfaces of said platelets carrying micromechanically generated structures which interact to form reaction chambers for the execution of chemical reactions. At least one channel is present which leads through the system and is connected to the inlet and to the outlet.

The flow rates of the material flows are limited by the apparatus: for example, by the pressures which establish themselves in accordance with the geometric configuration of the microreactor. It is desirable for the reaction in the microreactor to proceed to completion; however, there may also be a dwell zone, in order to provide for any dwell time that may be necessary.

The flow rates amount, in dependence on viscosity, appropriately to between 0.05 and 5 l/min, preferably between 0.05 and 500 ml/min, more preferably between 0.05 and 250 ml/min, and in particular between 0.1 and 100 ml/min. In microjet reactors the flow rates are in the range from 100 ml/min to 2000 ml/min.

The redox electrode (1) and reference electrode (5) are connected to the reservoir vessels A (coupling components) and B (diazo component), and the pH electrode to the reservoir vessel C (buffer, alkali, acid). The volume streams A, B, and C are controlled by way of customary regulable conveying devices, such as pumps or valves, for example.

Example C.I. Pigment Red 2: Preparation of a diazonium salt solution:

A 500 ml three-neck flask is charged with 14.6 g of solid 2,5-dichloroaniline in 25.1 ml of water and this initial charge is admixed with 30.8 ml of 31% strength hydrochloric acid. Stirring at room temperature for 8 hours produces a hydrochloride solution. Following the addition of a further 25.1 ml of water and 3.75 ml of 60% strength acetic acid the reaction mixture is cooled to −5° C. At this temperature 11.5 ml of 40% strength sodium nitrite solution are added dropwise to the reaction mixture over about 15 minutes and stirring is continued at 0° C. for 60 minutes more. The reaction mixture is clarified by adding six spatula tips of ®Celite, which are quickly filtered off with suction. The yellowish diazonium salt solution is made up with water to a total volume of 300 ml (˜0.3 M).

Preparation of a solution of the coupling component:

A second flask is charged with 23.9 g of Naphtol AS in 50.2 ml of water and this initial charge is admixed with 26.7 ml of 25% strength sodium hydroxide solution. This mixture is then stirred at 60° C. for 120 minutes and brought into solution. It is rapidly filtered with suction and again made up with water to a total volume of 300 ml (˜0.3M).

Azo coupling in a microreactor The diazonium salt solution (reactant stream B) and Naphtol solution (reactant stream A) are pumped using calibrated piston pumps at a flow rate of 6 ml/min in each case to the respective reactant inlets of a microreactor (®Selecto type, Cellular Process Chemistry GmbH, Frankfurt/Main). The actual azo coupling reaction takes place in the reactor chamber. In order to produce a buffer effect, these reactant solutions are diluted a short way upstream of the reactor inlets with an acetic acid solution (4 ml of 60% strength acetic acid and 600 ml of water). The acetic acid solution is likewise conveyed into the reactant feed lines of the microreactor by means of calibrated piston pumps at a flow rate of 6 ml/min in each case, by way of a T-branch. Connected to the heat exchanger circuit of the microreactor is a thermostat, which sets a reaction temperature of 40° C. The pH of the product suspension at the reactor outlet, when the volume streams of the reactants are correctly set, is 2-3.

Regulation: With constant inflow of reactants and at constant pH, a sample is taken following exit from the reactor. An analytical technique such as TLC or HPLC is used to examine for any possible excess of a component and/or a spot test with H-acid solution (CAS No. 90-20-0) is carried out in order to detect an excess of diazonium salt or with fast blue salt solution (CAS No. 20282-70-6) for excess of coupling material. Depending on this result the reactant streams, diazonium salt solution and/or Naphtol solution, are corrected. If it is no longer possible to determine an excess of one of the reactants, the redox potential is fixed at a constant pH, e.g., 187 mV when using a tungsten electrode against Ag/AgCl. For the further course of the azo coupling reaction, any deviation from this fixed redox potential is corrected by appropriately modifying the reactant streams A and/or B. Redox potential: The potential range in the case of this pigment synthesis lies in the range from −200 to +250 mV, depending on electrode material.

1. A method of regulating the metered addition of reaction components in a continuous azo coupling reaction, which comprises measuring the redox potential of a reaction mixture online in the main flow following its exit from a continuously operated reactor in a flow measurement cell with the aid of a rotating redox electrode arranged transversely to the flow direction of the reaction mixture.

2. The method as claimed in claim 1, wherein the metered addition of the coupling component and/or of the diazo component is regulated.

3. The method as claimed in claim 1 or 2, wherein an educt stream A comprising a solution or suspension of the coupling component, an educt stream B comprising a solution or suspension of diazo component, and, where appropriate, a volume stream C comprising a buffer solution, an acid or an alkali are regulated online.

4. The method as claimed in at least one of claims 1 to 3, wherein the metered addition of the reaction components takes place by comparing the measurement signal of the redox electrode with the setpoint value of the redox potential at constant pH.

5. A flow measurement cell for implementing the method as claimed in one or more of claims 1 to 4, characterized by a rotating redox electrode (1) arranged approximately in the middle of the flow tube (2) of the flow measurement cell transversely to the flow direction of the reaction mixture and mounted rotatably in a sliding contact (3) for picking up the signal; a rod-shaped body (4) which contacts the rotating redox electrode and has a cleaning action; a reference electrode (5); and pH electrode (6).

6. The flow measurement cell as claimed in claim 5, wherein the redox electrode (1) is composed of tungsten, Au, Pt, Ag, Sb, Mo, Cr, graphite or of at least 80% of one of the listed materials or of an alloy thereof.

7. The flow measurement cell as claimed in claim 5 or 6, wherein the sliding contact (3) is of copper.

8. The flow measurement cell as claimed in one or more of claims 5 to 7, wherein the rod-shaped body (4) is pressed onto the rotating redox electrode with the aid of a tracker device (7), preferably a spring.

9. The flow measurement cell as claimed in one or more of claims 5 to 8, wherein the rod-shaped body (4) is composed of an inert material, preferably of an abrasive material, or is coated with an inert material, preferably with an abrasive material.

10. The flow measurement cell as claimed in one or more of claims 5 to 9, wherein the rod-shaped body (4) is composed of polyvinyl difluoride, polytetrafluoroethylene, corundum, Arkansas stone or silicon carbide or is coated therewith.

11. The flow measurement cell as claimed in one or more of claims 5 to 10, wherein the reference electrode (5) is an Ag/AgCl electrode, calomel electrode or Pt/H₂ standard hydrogen electrode.

12. A device for implementing a continuous, online-regulated azo coupling reaction, characterized by a flow measurement cell (M) as claimed in one or more of claims 5 to 11 connected to a continuously operated reactor (R) and reservoir vessels (A, B, and, where appropriate, C).

13. The device as claimed in claim 12, wherein the continuously operated reactor is a microreactor or a microjet reactor.
